(19) United States
(12) Patent Application Publication
(10) Pub. No.: US 2024/0125359 A1
(43) Pub. Date: Apr. 18, 2024

(54) TRIPOD JOINT

(71) Applicants: GKN Driveline International GmbH, Lohmar (DE); GKN Driveline Zumaia SA, Zumaia (ES)

(72) Inventors: Orkan Eryilmaz, Lohmar (DE); Thomas Weckerling, Lohmar (DE); Julian Lehnert, Lohmar (DE); Hans-Jürgen Post, Lohmar (DE); Daniela Ballas, Lohmar (DE); Patricia Urbistondo, Zumaia (ES); Jesús Abenójar García-Minguillán, Zumaia (ES)

(21) Appl. No.: 18/484,508

(22) Filed: Oct. 11, 2023

(30) Foreign Application Priority Data
Oct. 14, 2022 (DE) 10 2022 126 926.4
Jun. 30, 2023 (DE) 10 2023 117 277.8

(51) Int. Cl. F16D 3/205

(52) U.S. Cl. CPC F16D 3/2055; F16D 2003/2026

(57) ABSTRACT

A tripod joint can include a joint outer part with a first longitudinal axis and a cavity running parallel to the first longitudinal axis with an open end, three recesses running parallel to the first longitudinal axis being formed in the joint outer part, and a joint inner part with a second longitudinal axis., The tripod joint can include at least one central body on which three trunnions are formed with trunnion axes extending radially from the second longitudinal axis, wherein a roller body is arranged on each of the trunnions, which roller body has at least one outer ring and an inner ring rotatable therewith about a common axis of rotation, as well as bearing bodies arranged between the outer ring and the inner ring; wherein each roller body is movably received in the recesses along the first longitudinal axis.

### CROSS-REFERENCE TO RELATED APPLICATIONS

This application claims priority to German Application No. DE 10 2022 126 926.4, filed on Oct. 14, 2022, and German Application No. DE 10 2023 117 277.8, filed on Jun. 30, 2023, which applications are hereby incorporated herein by reference in their entireties.

### BACKGROUND

A tripod joint having an outer joint part and an inner joint part with a central body, which has three integrally formed trunnions, such as for a motor vehicle can include an outer joint part with a first longitudinal axis and a cavity extending parallel to the first longitudinal axis and having an open end, wherein three recesses extending parallel to the first longitudinal axis are formed in the outer joint part. Further, the tripod joint comprises an inner joint part with a second longitudinal axis, comprising at least one central body to which three trunnions are formed with trunnion axes extending radially from the second longitudinal axis. A roller body is arranged on each of the trunnions, which has at least one outer ring and an inner ring rotatable about a common axis of rotation with respect to the outer ring, as well as bearing bodies arranged between the outer ring and the inner ring. Each roller body is movably received in a recess, movable along the first longitudinal axis.

The inner part of the joint can be inserted into the cavity of the outer part of the joint via the open end in order to assemble the tripod joint with the trunnions and roller bodies arranged thereon.

The central body can itself form a shaft or be connected to a shaft, e.g., via splines.

The inner part of the joint can be displaced along the first longitudinal axis relative to the outer part of the joint and can be deflected by a deflection angle relative to the outer part of the joint. The deflection angle is the smallest angle between the first and the second longitudinal axis.

Tripod joints have been manufactured and sold by the applicant for some time, for example under the name AAR tripod joints. They are used for side shafts of motor vehicles, which serve as the drive connection between a differential gear and the drive wheels. So-called constant velocity ball fixed joints are usually used on the wheel side and the AAR tripod joints mentioned here are used as sliding joints on the differential gear. The AAR tripod joints are designed for deflection angles of the order of 23 degrees to 26 degrees (or less).

In a sub-type of the AAR tripod joint 1, the AARi tripod joint, the inner ring is cylindrical towards the trunnion and the inner ring is fixed to the outer ring with respect to the direction along the axis of rotation by circlips.

The trunnion contacts the bearing body or the inner ring of the roller body via so-called sliding surfaces (contact surfaces), which are designed in the shape of a spherical segment. These sliding surfaces are aligned in a circumferential direction around the second longitudinal axis, so that a torque acting around the longitudinal axes of the joint is transmitted via the sliding surfaces of the trunnion to the roller body and from the roller body to the recesses (or vice versa).

During the operation of a motor vehicle, for example, different conditions can occur on a side shaft which extends essentially parallel to an axle of a motor vehicle and via which a wheel can thus be driven by a drive unit. In traction (pull) mode, the wheel is driven by the drive unit. In push mode, the motor vehicle is towed by the mass of the motor vehicle in momentum. For a tripod joint arranged on the side shaft, the contacts between the trunnions and the sliding surfaces of the roller bodies differ in certain states.

If, for example, the motor vehicle is driving forwards, the direction of rotation of the side shaft is constant. When changing between push and traction mode, the contacts between the trunnions and the sliding surfaces change. Even if the motor vehicle changes its direction of travel (from forward to reverse), the contact between the trunnion and the sliding surface changes to the other side of the trunnion as seen in the circumferential direction.

In a traction mode of a motor vehicle, i.e., when the motor vehicle is driven by a drive unit, the trunnion contacts the roller body with one of the sliding surfaces and the roller body contacts one side of the recesses in particular. In the case of a push mode or sail mode (both referred to as coasting) of the motor vehicle, i.e., when drive torques are introduced starting from the wheel and the drive unit is further connected (push mode) or disconnected (sailing operation), the trunnion contacts the roller body with the other of the sliding surfaces and the roller body contacts the other side of the recesses. In the push mode or the sail mode, the direction of the introduced torques and the direction of rotation of the joint are opposite to each other, in the traction mode they are in the same direction.

To achieve particularly advantageous guiding properties, an offset can be provided between the first pitch circle radii of the sliding surfaces of the trunnions (i.e., of the inner part of the joint) and the second pitch circle radii of the recesses (i.e., of the outer part of the joint).

The pitch circle radius of the trunnions or the inner part of the joint is the so-called effective radius. This is defined for an extended joint, i.e., the longitudinal axes are arranged coaxially to each other. The effective radius defines the lever arm of the force resultant when a torque is transmitted. The pitch circle radius of the trunnions or of the inner part of the joint is therefore the radius, starting from the second longitudinal axis of the inner part of the joint, on which, for example, the center points of the spherical segment-shaped sliding surfaces of the trunnion are arranged when the joint is elongated.

The pitch circle radius of the outer part of the joint or of the recesses is also here the so-called effective radius, which is defined for an elongated joint, i.e., the longitudinal axes are arranged coaxially to each other. The effective radius defines the lever arm of the force resultant when a torque is transmitted.

The definition of the pitch circle radius (also known as pitch circle radius—PCR) is basically known, especially also for tripod joints.

The offset of the pitch circle radii is therefore the difference between these pitch circle radii.

The properties of a tripod joint are also defined by a so-called ACFG value (Axial Cyclic Force Generation, unwanted axial forces generated by the joint). This value is given as the root mean square value of the force, with the unit Newton root mean square (Nrms). The value varies as a function of the deflection angle of the joint, whereby the course/curve of the value can be defined or determined as a function of the deflection angle for each joint. The range of use of the joint is thus limited by a maximum deflection angle at which the ACFG value does not exceed an amount that is still considered permissible.

Different designs of the roller bodies and the trunnions are known. In an example according to US 2008-194 341 A1, the bearing bodies are arranged in an installation space of the outer ring. The inner ring is displaceable along the common axis of rotation relative to the outer ring and the bearing bodies. The inner ring is locally fixed to the trunnion via two stops, i.e., the inner ring can be pivoted relative to the trunnion axis but cannot be displaced relative to the trunnion along the trunnion axis. In order to mount the roller body on the trunnion, it is necessary to pivot at least the inner ring relative to the trunnion axis to such an extent that it can be pushed onto the trunnion over the stops. However, the necessary pivoting means that a narrow transition area must be realized between the trunnion and the central body, into which the inner ring can dip during assembly. This narrower transition area can affect the application range of the joint, e.g., with regard to transmittable torques. In addition, the maximum possible deflection angle is limited by the stop arranged closer to the central body, which then collides with the central body.

In a similar design of the joint according to U.S. Pat. No. 6,533,668 B2, the inner ring is made narrower, but the bearing bodies are then partially exposed during operation of the joint and are not covered by or in contact with the inner ring.

In another example according to U.S. Pat. No. 6,572,481 B1, the inner ring is secured to the trunnion by only one stop, i.e., only the displacement of the inner ring towards the second longitudinal axis is limited. However, a stop is provided between the inner ring and the respective recess, which, however, leads to higher axial forces due to the friction occurring as a result of the sliding movement.

In a third embodiment according to EP 2 726 752 B1, the bearing bodies are arranged in an installation space of the inner ring. The inner ring together with the bearing bodies can be displaced along the common axis of rotation relative to the inner ring. The inner ring is fixed to the trunnion by two stops, i.e., the inner ring can be pivoted relative to the trunnion axis and can only be displaced a small distance relative to the trunnion along the trunnion axis. In addition to the disadvantages mentioned with reference to the first embodiment, there is also a movement between the stops and thus an alternating contact between the two stops.

In a fourth embodiment according to WO 2021/098945 A1, the inner ring is fixed relative to the outer ring, e.g., via circlips, so that a displacement of the inner ring relative to the outer ring along the axis of rotation is not possible. Stops between the trunnion and the inner ring are not provided. However, ACFG problems can occur in traction and push operation because the inner ring contacts the inner of the two circlips in the manner of a brake disc.

### SUMMARY

A tripod joint is described herein by which the ACFG forces can be reduced and the mountability of the roller body on the respective trunnion is ensured. For this purpose, the stops should be designed in a more advantageous way. In addition, the tripod joint should be designed to be more resilient.

Advantages are provided with a tripod joint according to features of the claims. It should be noted that the features listed individually in the various claims can be combined with each other in any technologically useful way and define further embodiments. In addition, the features indicated in the claims are described and explained in more detail in the description, whereby further embodiments are illustrated.

The present tripod joint includes
an outer joint part with a first longitudinal axis and a cavity extending parallel to the first longitudinal axis with an open end, wherein three recesses extending parallel to the first longitudinal axis are formed in the outer joint part, and
a joint inner part with a second longitudinal axis, comprising at least one central body on which three trunnions are formed with trunnion axes extending radially from the second longitudinal axis, wherein a roller body is arranged on each of the trunnions, which roller body has at least one outer ring and an inner ring rotatable therewith about a common axis of rotation, as well as bearing bodies arranged between the outer ring and the inner ring.

Each roller body is accommodated in the recesses and is movable along the first longitudinal axis. In an intended operation of the tripod joint, one of the inner ring and outer ring together with the bearing bodies is displaceable relative to the other of the inner ring and outer ring along the axis of rotation. The outer ring forms a first stop with the inner ring, which limits a displacement path L of the inner ring relative to the outer ring along the axis of rotation and away from the second longitudinal axis. Furthermore, at least when the axis of rotation and the trunnion axis are arranged coaxially, the inner ring forms a second stop with the trunnion, which limits a displacement of the inner ring along the trunnion axis towards the second longitudinal axis. In the intended operation, the displacement of the inner ring relative to the trunnion along the trunnion axis away from the second longitudinal axis is unrestricted, that is limited only by the first stop.

The roller body comprises the outer ring and the inner ring, which are rotatable relative to each other. For this purpose, bearing bodies (rolling elements, e.g., needle-shaped rolling elements) are arranged in a known manner between the inner ring and the outer ring. These bearing bodies are arranged in an installation space of the inner ring or the outer ring. A large number of these bearing bodies are arranged along the circumferential direction around the axis of rotation.

The rotation of the inner ring relative to the outer ring allows the roller body to roll along the recesses or raceways in the outer part of the joint, so that the inner part of the joint can be displaced along the first longitudinal axis relative to the outer part of the joint.

When the inner part of the joint is deflected, the roller bodies are guided further through the raceways, whereby at least the trunnions are pivoted relative to the roller bodies.

The roller bodies are guided by the recesses in such a way that pivoting of the roller bodies relative to the recesses is not possible.

Alternatively, when the inner part of the joint is deflected, the roller bodies are also pivoted relative to the recesses.

In addition to the relative rotation, the inner ring and the outer ring also perform a displacement along the common axis of rotation relative to each other.

The intended operation (or “operation”) of the tripod joint (also called joint) includes that the inner part of the joint and the outer part of the joint are arranged to each other as intended for the specific application. For example, all roller bodies are arranged in the recesses and the joint is operated only in a certain range of the deflection angle, e.g., between zero and 30 angular degrees or between zero and 26 angular degrees. Further, the torques considered permissible for the joint are transmitted between the outer joint part and the inner joint part, and displacement of the roller bodies along the first longitudinal axis occurs only to a certain extent.

Non-intended operation (or “non-operation”) includes, for example, assembling the joint or assembling joint parts, such as placing the roller bodies on the trunnions.

The outer ring forms with the inner ring (exactly or only) a first stop limiting a displacement path L of the inner ring with respect to the outer ring along the axis of rotation and away from the second longitudinal axis. This first stop is formed by a projection on the outer ring or on the inner ring, against which the inner ring or the outer ring abuts when the inner ring has covered the displacement path L. The inner ring can therefore be moved along this direction. The inner ring can therefore only be displaced along this direction, i.e., along the axis of rotation (away from the second longitudinal axis), as far as contacting the stop surfaces. In the other direction along the axis of rotation (i.e., towards the second longitudinal axis), the inner ring can be displaced indefinitely, e.g., during intended operation, at least relative to the outer ring, but not relative to the trunnion.

The starting point or zero point for the displacement path is the position of the inner ring when the joint is not deflected (i.e., coaxial arrangement of the longitudinal axes of the outer joint part and the inner joint part) starting from the PCR1, i.e., the PCR of the inner joint part. From there, at least the major part of the movement of the inner part of the joint (corresponding to the ROM, i.e., the displacement path of the respective trunnion starting from the PCR1 along the axis of rotation away from the second longitudinal axis) is made possible by the possible displacement path towards the first stop. Should the inner ring contact the outer ring at the first stop even before the maximum deflection angle is reached, the further movement of the inner part of the joint, up to the maximum deflection angle, which is (only) reached during assembly of the joint, can be taken up by the play of the respective roller body in the respective recess on the outer part of the joint.

At least when the axis of rotation and the trunnion axis are arranged coaxially, the inner ring forms a (or exactly or only one) second stop with the trunnion. The second stop limits a displacement of the inner ring along the trunnion axis towards the second longitudinal axis. In the intended use, i.e., when the inner joint part is arranged together with the outer joint part to form the tripod joint, the displacement of the inner ring relative to the trunnion along the trunnion axis away from the second longitudinal axis is unrestricted, i.e., limited only by the first stop. The outer ring is supported by the recesses so that the first stop then prevents further displacement of the inner part of the joint.

The first stop can limit a displacement of the inner ring in coast mode (push and sail mode).

The second stop can be used to control a displacement of the inner ring in traction mode.

The first stop is arranged along the axis of rotation on a first side of the bearing bodies facing towards the second longitudinal axis or on a second side of the bearing bodies facing away from the second longitudinal axis.

If the first stop is arranged along the axis of rotation on a first side of the bearing bodies facing towards the second longitudinal axis, it can be formed by a projection of the outer ring which extends along a radial direction away from the axis of rotation and thereby at least partially beyond the inner ring.

If the first stop is arranged along the axis of rotation on a second side of the bearing body facing away from the second longitudinal axis, it can be formed by a projection of the outer ring which extends inwards along a radial direction towards the axis of rotation and thereby at least partially beyond the inner ring.

The following applies to the displacement path L:

L>0.7*ROM

wherein for ROM applies:

ROM=0.5*PCR1*(1−cos(betaₘₐₓ));
with ROM as the displacement path of the trunnion starting from PCR1 along the axis of rotation away from the second longitudinal axis,
with PCR1 as the pitch circle radius of the inner part of the joint and
betaₘₐₓ as the maximum deflection angle of the tripod joint.

ROM, or the “radial outward movement of tripod peg” (that is the displacement of the trunnion in the radial outward direction), refers to the displacement of the PCR1 (pitch circle radius) of the inner part of the joint between a first state in which the longitudinal axes are coaxial to each other and a second state in which the longitudinal axes are maximally deflected to each other (maximum deflection angle is realized/present).

The inner ring, which is contacted via the second stop, is also displaced together with the trunnion. This displacement of the inner ring in relation to the outer ring should be realizable through the (possible) displacement path L, i.e., the inner ring should only form the first stop with the outer ring when the trunnion is displaced to the maximum (i.e., by ROM). In this case the following would apply: L>1.0*ROM. For extreme deflection angles (i.e., for deflection angles close to the maximum deflection angle) these usually only occur without load. In these cases, the displacement path L can also be somewhat smaller than ROM; L>0.7*ROM.

Each bearing body has a circumferential surface extending at least along the axis of rotation over a length for contacting a contact surface of the inner ring or outer ring which can be displaced along the axis of rotation with respect to the bearing bodies, wherein the circumferential surface contacts the contact surface with the entire length at any time during the intended operation.

The design of the inner ring, outer ring and bearing bodies takes into account all possible positions of the inner ring relative to the outer ring that the inner ring can assume during intended operation. This can prevent the bearing bodies from being only partially covered by the (inner or outer) ring, which can be displaced relative to the bearing bodies, during operation of the tripod joint.

However, it is also possible that in the intended operation, at least in individual arrangements of the tripod joint, the circumferential surface of the bearing bodies only contacts the contact surface of the respective ring over part of the length. However, only a part of the length of the circumferential surface of the bearing bodies is not contacted. This non-contacted part of the length is exclusively arranged directly adjacent to the second side of the bearing bodies facing away from the second longitudinal axis. However, the non-contacted length is at most 50%, at most 25%, preferably at most 10%, of the length of the contactable circumferential surface.

This embodiment can be chosen, for example, if a circlip is used to form the first stop, whereby this then also limits the installation space for the bearing bodies.

The inner ring forms a third stop with the trunnion, which limits displacement of the inner ring along the trunnion axis away from the second longitudinal axis. The inner ring and the trunnion contact each other via the third stop exclusively outside the intended operation and only in the event of an attempted disassembly of the inner ring from the trunnion.

The inner ring and the trunnion do not contact each other via the third stop (but only via the second stop) during the intended operation of the joint. The third stop allows such an extensive displacement of the inner ring relative to the trunnion that the inner ring and the trunnion cannot contact each other at all via the third stop while the inner part of the joint is arranged in the outer part of the joint. The third stop only serves as a disassembly protection for the inner ring or the roller body, so that at least the inner ring can be held on the trunnion by the third stop.

The third stop is realized by a projection on the inner ring, which extends from the inner ring towards the axis of rotation.

The inner ring can only be pushed onto the trunnion in a pivoted state relative to the trunnion axis due to the third stop. This pivoted state has a smallest angle (i.e., the smallest measurable angle) between the trunnion axis and the axis of rotation of 5 to 20 angular degrees, e.g., at most 15 angular degrees, or at most 10 angular degrees. The pivoted state has a smallest angle between the trunnion axis and the axis of rotation of at least 5 angular degrees, e.g., at least 10 angular degrees, or of at least 15 angular degrees.

Conversely, the inner ring can only be held on the trunnion if the angle between the trunnion axis and the axis of rotation is less than 5 angular degrees, less than 10 angular degrees, or less than 15 angular degrees.

The third stop is not contacted during the transmission of torques by the trunnion, so that it can be designed with correspondingly small dimensions. The small dimensioning means that only a small angle is required between the trunnion axis and the axis of rotation in order to arrange the inner ring on the trunnion. The small angle makes it possible to realize only a slightly narrower transition area between the trunnion and the central body, into which the inner ring can dip during assembly. This transition area, which is thicker than that of known joints, can increase the range of application of the joint, e.g., with regard to transmittable torques.

Also with the design of the third stop, the joint corresponds to the definition of the proposed joint given at the beginning, according to which the displacement of the inner ring relative to the trunnion along the trunnion axis away from the second longitudinal axis is unrestricted during the intended operation, i.e., is only limited by the first stop. The third stop only engages when the roller body is to be disassembled from the trunnion, i.e., in non-intended operation of the joint.

The displacement of the trunnion with respect to the inner ring is limited by the first stop and the third stop, the displacement being at least equal to RIM+ROM, that is to say:

Displacement≤RIM+ROM

where for RIM and ROM applies:

RIM=1.5*PCR1*(1−cos(betaₘₐₓ))

and

ROM=0.5*PCR1*(1−cos(betaₘₐₓ))
with RIM as the displacement path RIM of the trunnion starting from PCR1 along the axis of rotation towards the second longitudinal axis,
with ROM as the displacement path ROM of the trunnion starting from PCR1 along the axis of rotation away from the second longitudinal axis,
with PCR1 as pitch circle radius PCR1 of the inner part of the joint and betaₘₐₓ as the maximum deflection angle of the tripod joint.

The third stop is thus arranged so that the above condition is fulfilled, i.e., that the displacement (possible) between the stops is greater than or equal to the sum of RIM and ROM.

RIM, or also “radial inward movement of tripod peg” (that is the displacement of the trunnion in the radial inward direction), refers to the displacement of the PCR1 (pitch circle radius) of the inner part of the joint between a first state in which the longitudinal axes are arranged coaxially to each other and a second state in which the longitudinal axes are maximally deflected to each other (maximum deflection angle is present). The trunnion slides along the contact surface of the inner ring, which is cylindrical. This displacement RIM of the trunnion relative to the inner ring should be realizable, i.e., the trunnion should not (yet) form the third stop with the inner ring.

The displacement of the inner ring along the trunnion axis away from the second longitudinal axis with coaxial arrangement of the trunnion axis and the axis of rotation is also unrestricted outside the intended use. No third stop is provided.

The first stop is formed by the outer ring itself or by a circlip arranged on the outer ring. The circlip can, for example, be designed in the form of a so-called snap ring. The circlip may be arranged in a circumferential groove on the outer ring, protruding from the groove so that the circlip contacts the inner ring when the latter is displaced sufficiently far along the axis of rotation and away from the second longitudinal axis.

A circlip or the groove required for it requires additional construction space, so that the roller body may have to be made larger. On the other hand, the outer ring can be manufactured more economically if a circlip is provided instead of a projection formed on the outer ring.

An installation space for the bearing bodies on the outer ring is limited by a circlip arranged on the outer ring. The installation space is limited on both sides of the bearing bodies, i.e., towards the second longitudinal axis on the first side and on the second side facing away from the second longitudinal axis, by one circlip each.

The inner ring has a stepped shape in a first cross-section (transverse to the second longitudinal axis), so that a contact surface of the inner ring cooperating with the bearing body is arranged offset inwards (i.e., towards the longitudinal axis) along the axis of rotation relative to an end surface of the inner ring. The end surface of the inner ring is the surface of the inner ring lying furthest outwards (outwards along the axis of rotation, i.e., away from the longitudinal axis).

The circlip (for the first stop and/or the third stop) has a stepped shape in a cross-section, so that a first stop of the circlip acting towards the inner ring is arranged along the axis of rotation (outwards, i.e., away from the longitudinal axis) offset from the groove in the outer ring or from a fourth stop formed by the circlip towards the bearing bodies.

The stepped shape may comprise sections extending at right angles to each other or sections extending at an angle to each other.

The circlip is slotted so that it is elastically deformable for mounting in the groove of the outer ring.

The second stop can be formed by a circlip arranged in a groove on the inner ring. The circlip used for the second stop has a round cross-section, but possibly also a polygonal, square, trapezoidal or stepped cross-section. The explanations regarding the shape of the circlip provided for the first or third stop apply in the same way.

If a circlip is used for the second stop, the inner ring can be provided with a cylindrical inner circumferential surface, whereby a groove for receiving the circlip is then provided in the inner circumferential surface.

In particular, in a cross-section extending transversely to the second longitudinal axis and between a PCR1 of the inner part of the joint and the central body, the inner part of the joint has a smallest first wall thickness present along a circumferential direction about the second longitudinal axis and a greatest second wall thickness on the radius of the PCR1. The ratio of the first wall thickness to the second wall thickness is at least 0.7, at least 0.9, or at least 0.95, with PCR1 as the pitch circle radius of the inner joint part.

The small angle between the axis of rotation and the axis of the pivot, which is required for mounting/dismounting the inner ring on/from the trunnion, makes it possible to realize an only slightly narrower transition area between the trunnion and the central body, into which the inner ring can dip during mounting or intended operation. This first wall thickness, which is thicker than that of known joints, can increase the range of application of the joint, e.g., with regard to transmittable torques.

A PCR1 of the inner part of the joint is smaller than a PCR2 of the outer part of the joint, the PCR being the pitch circle radius.

The outer ring has a maximum diameter d in a cross section encompassing the axis of rotation and an outer circumferential surface of the outer ring is formed by a radius; where 0.5<2*r/d<1.5. If 2*r=d, a spherical outer circumferential surface is present.

For example, if the outer ring of the roller body has a spherical outer contour on its outer circumferential surface, the outer ring can be pivoted or swiveled about the center axis of the recess of the outer joint part in the circumferential direction of the central body. The recess in the outer part of the joint is shaped accordingly, so that the roller body is not fixed in the circumferential direction of the outer part of the joint, but can be pivoted on both sides with respect to the central axis of the recess in a range of 0 to 5 angular degrees, 0 to 3 angular degrees, in accordance with an orbital movement caused. This pivoting is referred to as orbital movement or orbital angle. The central axis of the path is the axis of each recess in the outer part of the joint, along which the roller bodies can move as a result of the axial forces in the outer part of the joint.

In this case, the angular compensation of the orbital movement can also take place at least partially between the trunnion and the inner ring. For this purpose, the circumferential surface of the trunnion must be convexly curved. The convex shape of this surface implies that the surface is designed according to a spherical segment, a barrel segment, a toroidal segment or a cylindrical segment.

The embodiments of tripod joints listed here allow, in the case of use, a deflection of the inner part of the joint relative to the outer part of the joint, i.e., the second longitudinal axis relative to the first longitudinal axis, of up to at least 30 angular degrees, of up to 32 angular degrees or up to 36 angular degrees. This deflection is referred to as the deflection angle.

Furthermore, a motor vehicle with at least one tripod joint is also described herein.

The use of indefinite articles (“a”, “one”), in the claims and the description reproducing them, is to be understood as such and not as a numeral. Terms or components introduced accordingly are thus to be understood as being present at least once and, As being present more than once.

As a precaution, it should be noted that the number words used here (“first”, “second”, . . . ) primarily (only) serve to distinguish between several similar objects, variables or processes, i.e., they do not necessarily specify a dependency and/or sequence of these objects, variables or processes in relation to one another. If a dependency and/or sequence is required, this is explicitly stated here or it is obvious to the person skilled in the art when studying the concretely described embodiment. Insofar as a component may occur several times (“at least one”), the description of one of these components may apply equally to all or part of the majority of these components, but this is not mandatory.

### BRIEF SUMMARY OF THE DRAWINGS

The invention and the technical environment are explained in more detail below with reference to the accompanying figures. It should be noted that the invention is not to be limited by the examples of design variants given. It should be noted that the figures and, that the proportions shown are only schematic. They show:

FIG. 1: a detail of a cross-section of a first design variant of a tripod joint;

FIG. 2: a diagram showing several angular positions of a tripod joint;

FIGS. 3a)-d): a deflected tripod joint in different positions in traction mode;

FIGS. 4a)-d): the deflected tripod joint according to FIG. 3 in different positions in push mode;

FIG. 5: the diagram according to FIG. 2;

FIG. 6: a deflected tripod joint in the zero angular degree position;

FIG. 7: the deflected tripod joint according to FIG. 6 in the 90 angular degree position;

FIG. 8: the deflected tripod joint according to FIG. 7 in the 180 angular degree position;

FIG. 9: the deflected tripod joint according to FIG. 8 in the 270 angular degree position;

FIG. 10: the detail of a cross-section according to FIG. 1;

FIG. 11: a detail of a cross-section of a second design variant of a tripod joint;

FIG. 12: a representation of a displacement path ROM of the trunnion of a tripod joint between a non-deflected and a maximally deflected position;

FIG. 13: a detail of a cross-section of a third design variant of a tripod joint;

FIG. 14: a detail of a cross-section of a fourth design variant of a tripod joint;

FIG. 15: a detail of a cross-section of a fifth design variant of a tripod joint;

FIG. 16: a detail of a cross-section of a sixth design variant of a tripod joint;

FIG. 17: the detail according to FIG. 1 with a first feature;

FIG. 18: the detail according to FIG. 1 with a second feature;

FIG. 19: a representation of the displacement paths RIM and ROM of the trunnion of a tripod joint between a non-deflected and a maximally deflected position;

FIG. 20: a first diagram;

FIG. 21: a second diagram;

FIG. 22: a third diagram;

FIG. 23: a fourth diagram;

FIG. 24: a detail of a cross-section of a seventh design variant of a tripod joint;

FIG. 25: a side view of the circlip forming the first stop according to FIG. 24;

FIG. 26: the circlip according to FIG. 25 in a plan view;

FIG. 27: a detail of a cross-section of an eighth design variant of a tripod joint;

FIG. 28: a detail of a cross-section of a ninth design variant of a tripod joint; and

FIG. 29: a detail of a cross-section of a tenth design variant of a tripod joint.

### DESCRIPTION

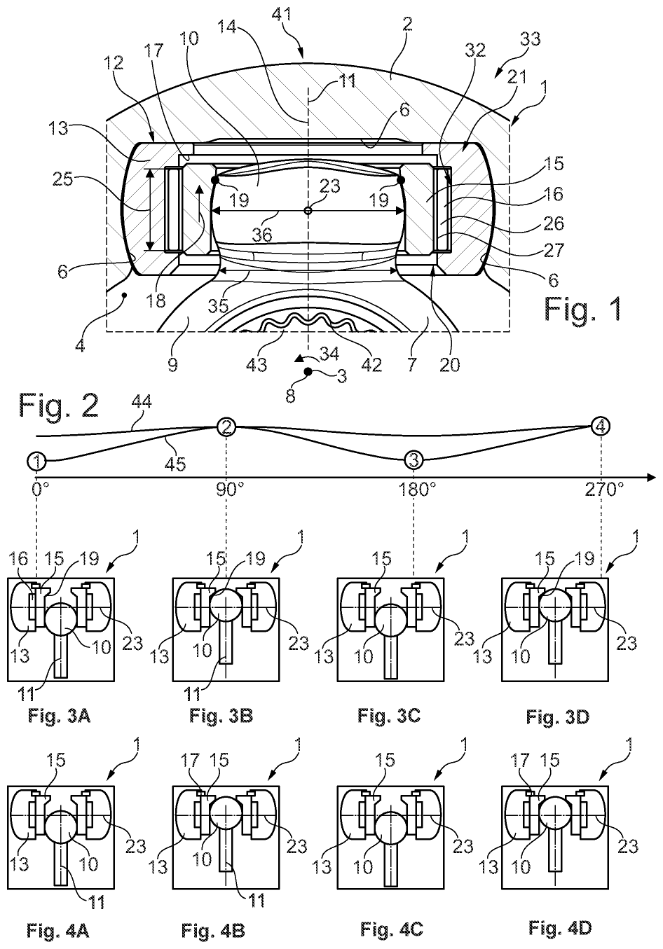

FIG. 1 shows a detail of a (first) cross-section 33 of a first design variant of a tripod joint 1. The tripod joint 1 comprises a joint outer part 2 with a first longitudinal axis 3 and a cavity 4 running parallel to the first longitudinal axis 3 with an open end 5, wherein three recesses 6 running parallel to the first longitudinal axis 3 are formed in the joint outer part 2. Furthermore, the tripod joint 1 comprises an inner joint part 7 with a second longitudinal axis 8. The inner joint part 7 comprises a central body 9 on which three trunnions 10 are formed with trunnion axes 11 extending radially from the second longitudinal axis 8. A roller body 12 is arranged on each of the trunnions 10, which roller body 12 has at least one outer ring 13 and an inner ring 15 rotatable about a common axis of rotation 14 and bearing bodies 16 arranged between the outer ring 13 and the inner ring 15.

Each roller body 12 is accommodated in the recesses 6 and is movable along the first longitudinal axis 3. In an intended operation of the tripod joint 1, the inner ring 15 is displaceable relative to the outer ring 13 and the bearing bodies 16 along the axis of rotation 14. The outer ring 13 forms a first stop 17 with the inner ring 15, which limits a displacement path L 18 of the inner ring 15 relative to the outer ring 13 along the axis of rotation 14 and away from the second longitudinal axis 8. Furthermore, at least when the axis of rotation 14 and the trunnion axis 11 are arranged coaxially, the inner ring 15 forms a second stop 19 with the trunnion 10, which limits a displacement of the inner ring 15 along the trunnion axis 11 towards the second longitudinal axis 8. In the intended operation, the displacement of the inner ring 15 relative to the trunnion 10 along the trunnion axis 10 away from the second longitudinal axis 8 is unrestricted, i.e., limited only by the first stop 17.

The roller body 12 comprises the outer ring 13 and the inner ring 15, which are rotatable relative to each other. For this purpose, bearing bodies 16 (rolling bodies, here needle-shaped rolling bodies) are arranged in a known manner between the inner ring 15 and the outer ring 13. These bearing bodies 16 are arranged in an installation space 32 of the outer ring 13. A plurality of these bearing bodies 16 are arranged along the circumferential direction 34 around the axis of rotation 14.

The rotation of the inner ring 15 relative to the outer ring 13 allows the roller body 12 to roll along the recesses 6 or raceways in the joint outer part 2, so that the joint inner part 7 is displaceable along the first longitudinal axis 3 relative to the joint outer part 2.

When the inner joint part 7 is deflected, the roller bodies 12 are further guided by the recesses 6, whereby at least the trunnions 10 are pivoted relative to the roller bodies 12.

When the inner joint part 7 is deflected, the roller bodies 12 can also be pivoted to a small extent relative to the recesses 6.

In addition to the relative rotation, the inner ring 15 and the outer ring 13 also perform a displacement along the common axis of rotation 14 in relation to each other.

The intended operation of the tripod joint 1 includes that the inner joint part 7 and the outer joint part 2 are arranged in relation to each other as intended for the specific application. For example, all roller bodies 12 are arranged in the recesses 6 and the joint 1 is only operated in a certain range of the deflection angle 24, e.g., between zero and 30 angular degrees or between zero and 26 angular degrees. Furthermore, the torques considered permissible for the joint 1 are transmitted between the outer joint part 2 and the inner joint part 7 and a displacement of the roller bodies 12 along the first longitudinal axis 3 occurs only to a certain extent.

Non-intended operation includes, for example, assembling the joint 1 or assembling joint parts, for example, arranging the roller bodies 12 on the trunnions 10.

The outer ring 13 forms with the inner ring 15 exactly or only one first stop 17, which limits a displacement path L 18 of the inner ring 15 relative to the outer ring 13 along the axis of rotation 14 and away from the second longitudinal axis 8. This first stop 17 is formed by a projection on the outer ring 13, against which the inner ring 15 abuts when the inner ring 15 has covered the displacement path L 18. The inner ring 15 can therefore only be displaced along this direction, i.e., along the axis of rotation 14 away from the second longitudinal axis 8, as far as the contacting of the stop surfaces. In the other direction along the axis of rotation 14, i.e., towards the second longitudinal axis 8, the inner ring 15 can be displaced indefinitely during intended operation (limited only by the second stop 19).

At least when the axis of rotation 14 and the trunnion axis 11 are arranged coaxially, the inner ring 15 forms exactly or only one second stop 19 with the trunnion 10. The second stop 19 limits a displacement of the inner ring 15 along the trunnion axis 11 towards the second longitudinal axis 8. In the intended operation, when the inner joint part 7 is arranged together with the outer joint part 2 to form the tripod joint 1, the displacement of the inner ring 15 relative to the trunnion 10 along the trunnion axis 11 away from the second longitudinal axis 8 is unrestricted, i.e., limited only by the first stop 17. The outer ring 13 is supported by the recesses 6, so that the first stop 17 then prevents further displacement of the inner joint part 7.

By means of the first stop 17, a displacement of the inner ring 15 can be limited in coast mode (push and sail mode).

The second stop 19 can be used to control a displacement of the inner ring 15 in traction mode.

The first stop 17 is arranged along the axis of rotation 14 on a second side 21 of the bearing bodies 16 facing away from the second longitudinal axis 8. The first stop 17 is formed by a projection of the outer ring 13 which extends along a radial direction towards the axis of rotation 14 and thereby at least partially beyond the inner ring 15.

Each bearing body 16 has a circumferential surface 26 extending at least along the axis of rotation 14 over a length 25 for contacting a contact surface 27 of the inner ring 15 which is displaceable relative to the bearing bodies 16 along the axis of rotation 14, wherein during intended operation the circumferential surface 26 contacts the contact surface 27 with the largest part of the length 25 at any time.

The design of the inner ring 15, outer ring 13 and bearing bodies 16 takes into account all possible positions of the inner ring 15 relative to the outer ring 13 that the inner ring 15 can assume during intended operation. In certain design variants of the tripod joint 1, it can thus be prevented that the bearing bodies 16 are only partially covered by the inner ring 15, which is displaceable relative to the bearing bodies 16, during operation of the tripod joint 1.

The displacement of the inner ring 15 along the trunnion axis 11 away from the second longitudinal axis 8 with coaxial arrangement of the trunnion axis 11 and the axis of rotation 14 is here also unrestricted outside the intended use. There is precisely no third stop 28 provided, which is shown in FIG. 13, for example.

In a first cross-section 33 extending transversely to the second longitudinal axis 8 and between a PCR1 23 of the inner joint part 7 and the central body 9, the inner joint part 7 has a smallest first wall thickness 35 along a circumferential direction 34 around the second longitudinal axis 8 and a greatest second wall thickness 36 on the radius of the PCR1 23. The first wall thickness 35 can be made particularly large due to the particular shape of the inner ring 15, which is substantially cylindrical. Firstly, a pivoting/tilting of the inner ring 15 for mounting on the trunnion 10 is not necessary and secondly, there is no third stop 28 or similar thickening of the inner ring 15 in the region of the first side 20 of the bearing bodies 16, which would form a stop with this region of the inner joint part 7 if the inner ring 15 were pivoted.

The angle between the axis of rotation 14 and the axis of the trunnion 11, which is not required here during assembly/disassembly of the inner ring 15 on/from the trunnion 10, thus makes it possible for an only slightly narrower transition area (first wall thickness 35) to be realized between the trunnion 10 and the central body 9, into which the inner ring 15 can dip during the intended operation of the tripod joint 1. This first wall thickness 35, which can be made thicker than in known joints 1, can increase the application range of the joint 1, e.g., with regard to transmittable torques.

The inner part of the joint 7 has splines 42 on the central body 9 for connection to a shaft 43. The tripod joint 1 can be used in a motor vehicle 41 (only indicated here), e.g., for connecting the shafts 43 between a differential gear and the drive wheels, for use with side shafts of a motor vehicle 41, which serve e.g., the drive connection (i.e., the connection of the wheels with a drive unit).

FIG. 2 shows a diagram with several angular positions of a tripod joint 1 deflected by a deflection angle 24 of 20 angular degrees. Reference is made to the explanations for FIG. 1.

Here the angular position of the cross-section of the joint 1 shown in FIGS. 3 and 4 is shown along the horizontal axis. The first curve 44 indicates the position of the inner ring 13 relative to the first longitudinal axis 3 or relative to a center line of the respective recess 6. The second curve 45 indicates the position of the trunnion 10 relative to the first longitudinal axis 3.

FIG. 3 shows a tripod joint 1 (or a trunnion 10 and the roller body 12) deflected by 20 angular degrees in the different positions of FIG. 2 in traction mode. FIG. 4 shows the deflected tripod joint 1 according to FIG. 3 in the different positions of FIG. 2 in push mode. FIG. a) shows the tripod joint 1 in the position zero or 360 angular degrees, FIG. b) in the position 90 angular degrees, FIG. c) in the position 180 angular degrees and FIG. d) in the position 270 angular degrees. FIGS. 3 and 4 are described together below. Reference is made to the explanations of FIGS. 1 and 2.

By means of the first stop 17 a displacement of the inner ring 15 can be limited in coast mode (push and sail mode) (see FIGS. 4b) and d)).

By means of the second stop 19, a displacement of the inner ring 15 in traction mode can be controlled (see FIGS. 3b) and d)).

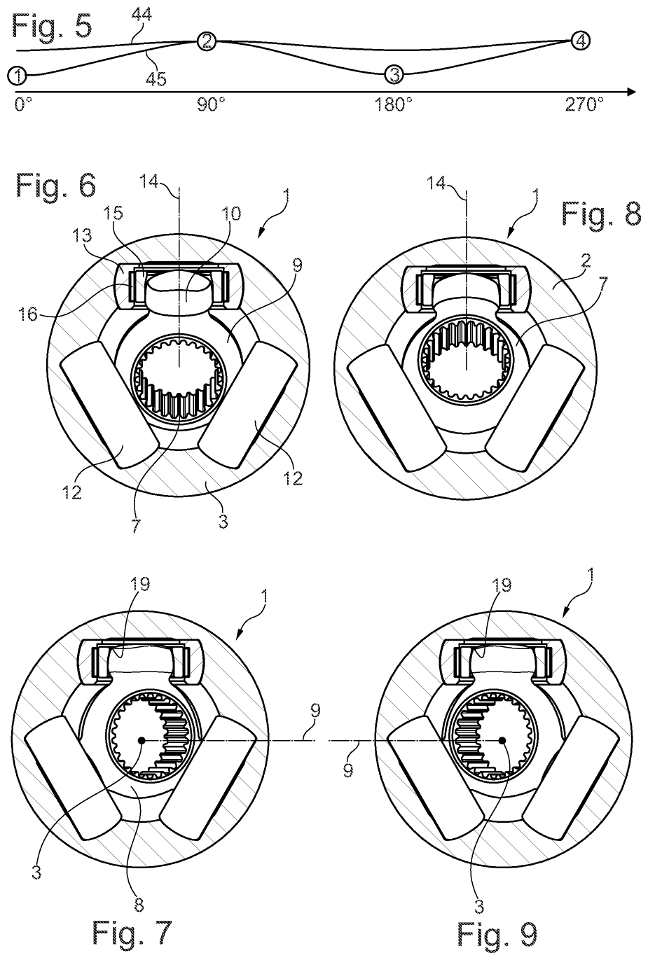

FIG. 5 shows the diagram according to FIG. 2. FIG. 6 shows a tripod joint 1 deflected by 20 angular degrees in the zero angular degree position in traction mode. FIG. 7 shows the deflected tripod joint 1 according to FIG. 6 in the 90 angular degree position in traction mode. FIG. 8 shows the deflected tripod joint 1 according to FIG. 7 in the 180 angular degree position in traction mode. FIG. 9 shows the deflected tripod joint 1 according to FIG. 8 in the 270 angular degree position in traction mode. FIGS. 5 to 9 thus show the different positions of the tripod joint 1 shown only schematically in FIGS. 2 to 4 using a tripod joint 1 that is not shown schematically. FIGS. 5 to 9 are described together below. Reference is made to the explanations of FIGS. 2 to 4.

By means of the second stop 19, a displacement of the inner ring 15 can be controlled during traction mode (see FIGS. 7 and 9 and compare FIGS. 3b) and d)). The displacement of the inner ring 15 along the axis of rotation 14 and away from the second longitudinal axis 8 is noticeable. However, there is no contact with the first stop 17. This only occurs in push mode.

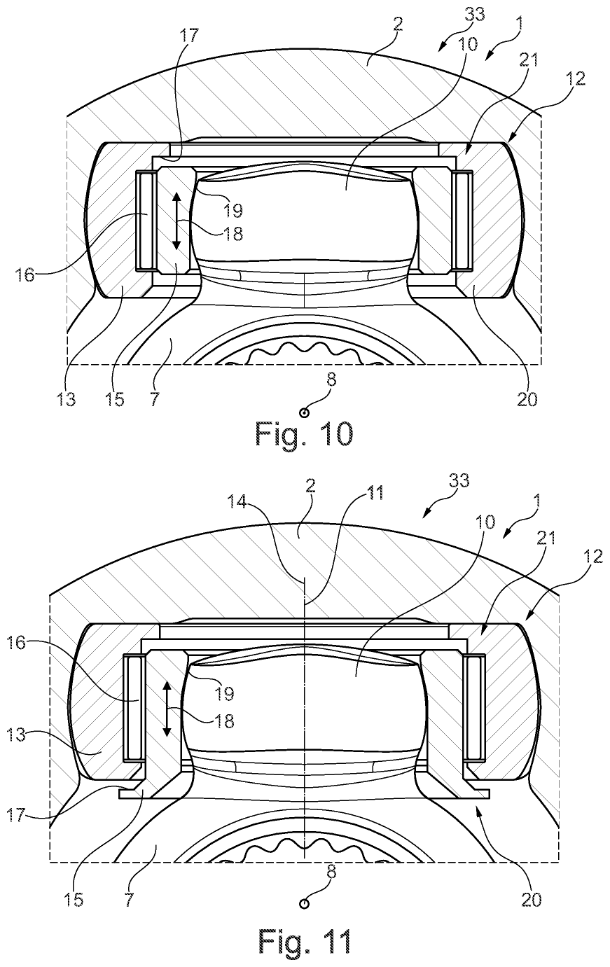

FIG. 10 shows the detail of the cross-section 33 according to FIG. 1. FIG. 11 shows a detail of a (first) cross-section 33 of a second design variant of a tripod joint 1. FIGS. 10 and 11 are described together below. Reference is made to the explanations of FIG. 1.

In FIG. 10, the first stop 17 is arranged along the axis of rotation 14 on a second side 21 of the bearing body 16 facing away from the second longitudinal axis 8. The first stop 17 is formed by a projection of the outer ring 13 which extends along a radial direction towards the axis of rotation 14 and thereby at least partially beyond the inner ring 15.

In FIG. 11, the first stop 17 is formed by a projection on the inner ring 15, against which the outer ring 13 abuts when the inner ring 15 has covered the displacement path L 18. The inner ring 15 can therefore only be displaced along this direction, i.e., along the axis of rotation 14 and away from the second longitudinal axis 8, as far as the contacting of the stop surfaces. In the other direction along the axis of rotation 14, i.e., towards the second longitudinal axis 8, the inner ring 15 can be displaced without limitation, in the intended operation, or only limited by the second stop 19.

In FIG. 11, the first stop 17 is arranged along the axis of rotation 14 on a first side 20 of the bearing bodies 16 pointing towards the second longitudinal axis 8. It will be formed by a projection of the inner ring 15 extending outwardly along a radial direction away from the axis of rotation 14 and thereby at least partially beyond the outer ring 15.

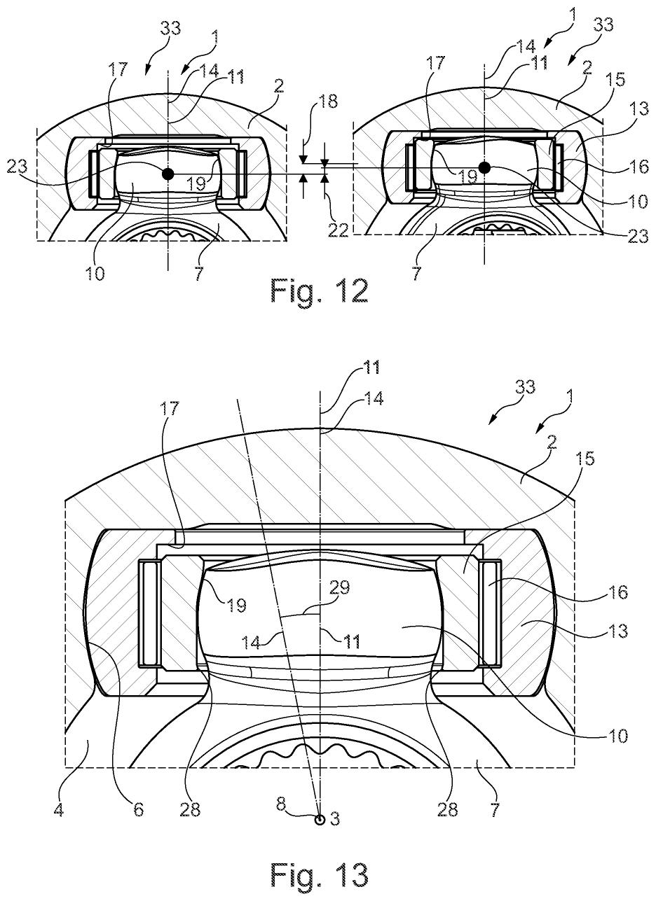

FIG. 12 shows a representation of a displacement path ROM 22 of the trunnion 10 of a tripod joint 1 between a non-deflected position (left representation) and a maximally deflected position (right representation, here in the 90 angular degree position).

For the displacement path L 18 to be allowed by the tripod joint 1 the following applies:

L>0.7*ROM

wherein for the displacement path ROM 22 the following applies:

ROM=0.5*PCR1*(1−cos(betaₘₐₓ));
with ROM as displacement path ROM 22 of the trunnion 10 starting from the PCR1 23 along the axis of rotation 14 away from the second longitudinal axis 8,
with PCR1 as pitch circle radius PCR1 23 of the inner joint part 7 and
betaₘₐₓ as the maximum deflection angle 24 of the tripod joint 1.

ROM, or “radial outward movement of tripod peg” (i.e., the radial outward movement of the trunnion 10 relative to the first longitudinal axis 3) refers to the movement of the PCR1 23 (pitch circle radius) of the inner joint part 7 between a first state in which the longitudinal axes 3, 8 are arranged coaxially to one another (see left-hand illustration) and a second state in which the longitudinal axes 3, 8 are deflected from one another to a maximum extent (maximum deflection angle 24 is present, see right-hand illustration). The inner ring 15, which is contacted via the second stop 19, is displaced together with the trunnion 10. This displacement of the inner ring 15 relative to the outer ring 13 should be realizable by the (possible) displacement path L 18, i.e., the inner ring 15 should only form or contact the first stop 17 with the outer ring 15 when the trunnion 10 is displaced to the maximum (i.e., by ROM 22). In FIG. 12 the possible displacement path L 18 is indicated, which here is greater than the displacement path ROM 22. In the right-hand illustration it can be seen that there is still play between the inner ring 15 and the first stop 17, this play representing the difference between L 18 and ROM 22.

If the possible displacement path L 18 is smaller than ROM, the displacement path ROM 22 of the trunnion 10 can be compensated by a play of the roller bodies 12 in the recesses. The possible displacement path L 18 should then allow for all displacement paths ROM 22 occurring during operation of the joint 1, whereby the displacement path ROM 22 is then compensated for by the play between roller bodies 12 and recesses 6 in the case of very large deflection angles 24 (which occur, for example, only during assembly of the joint 1).

FIG. 13 shows a detail of a (first) cross-section 33 of a third design variant of a tripod joint 1. Reference is made to the explanations in FIGS. 1 and 10.

The inner ring 15 forms a third stop 28 with the trunnion 10, which limits displacement of the inner ring 15 along the trunnion axis 11 away from the second longitudinal axis 8. The inner ring 15 and the trunnion 10 contact each other via the third stop 28 only outside of intended operation and only in the event of an attempted disassembly of the inner ring 15 from the trunnion 10.

The inner ring 15 and the trunnion 10 therefore do not contact each other via the third stop 28 during the intended operation of the joint 1, but exclusively via the second stop 19. The third stop 28 allows such a far-reaching displacement of the inner ring 15 relative to the trunnion 10 that the inner ring 15 and the trunnion 10 cannot contact each other at all via the third stop 28 while the inner joint part 7 is arranged in the outer joint part 2. The third stop 28 therefore only serves as a disassembly protection for the inner ring 15 or the roller body 12, so that at least the inner ring 15 can be held on the trunnion 10 by the third stop 28.

The third stop 28 is realized by a projection on the inner ring 15, which extends from the inner ring 15 or the inner circumferential surface of the inner ring 15, which is otherwise cylindrical up to the second stop 19, towards the axis of rotation 14.

Due to the third stop 28, the inner ring 15 can only be pushed onto the trunnion 10 in a pivoted state relative to the trunnion axis 11 (in not intended operation, e.g., during assembly of the inner ring 15). This pivoted state has a smallest angle 29 (only indicated here) between the trunnion axis 11 and the axis of rotation 14 of 5 to 20 angular degrees.

In the contrary, the inner ring 15 can therefore be held on the trunnion 10 (in non-intended operation, i.e., e.g., when the inner ring 15 is disassembled) only if the smallest angle 29 between the trunnion axis 11 and the axis of rotation 14 is less than, e.g., 5 angular degrees.

The third stop 28 is not contacted by the trunnion 10 during the transmission of torques (i.e., in intended operation), so that the third stop 28 can be designed with correspondingly small dimensions. The small dimensioning leads to the fact that only a smallest angle 29 between the trunnion axis 11 and the axis of rotation 14 is required in order to arrange the inner ring 15 on the trunnion 10. The small angle 29 makes it possible to realize a transition area (first wall thickness 35) between the trunnion 10 and the central body 9 that is only slightly narrower, into which the inner ring 15 can dip during assembly. This transition area (first wall thickness 35), which is thicker than that in known joints 1, can increase the application range of the joint 1, e.g., with regard to transmittable torques.

Also with the design of the third stop 29, the joint 1 corresponds to the definition of the proposed joint 1 given at the beginning, according to which, in the intended operation, the displacement of the inner ring 15 relative to the trunnion 10 along the trunnion axis 11 away from the second longitudinal axis 8 is unrestricted, i.e., limited only by the first stop 17. The third stop 28 only engages when the roller body 12 is to be disassembled from the trunnion 10, i.e., in non-intended operation of the joint 1.

FIG. 14 shows a detail of a (first) cross-section 33 of a fourth design variant of a tripod joint 1. Reference is made to the explanations on FIGS. 1 and 10.

The first stop 17 is formed by a circlip 31 arranged on the outer ring 13. The circlip 31 is designed in the form of a so-called snap ring. The circlip is arranged in a circumferential groove on the outer ring 13 and projects out of the groove so that the circlip contacts the inner ring 15 when the latter is displaced sufficiently far along the axis of rotation 14 and away from the second longitudinal axis 8.

A circlip 31 or the groove required for it requires additional construction space, so that the roller body 12 may have to be made larger. On the other hand, the outer ring 13 can be manufactured more economically if a circlip is provided instead of a projection formed on the outer ring 13.

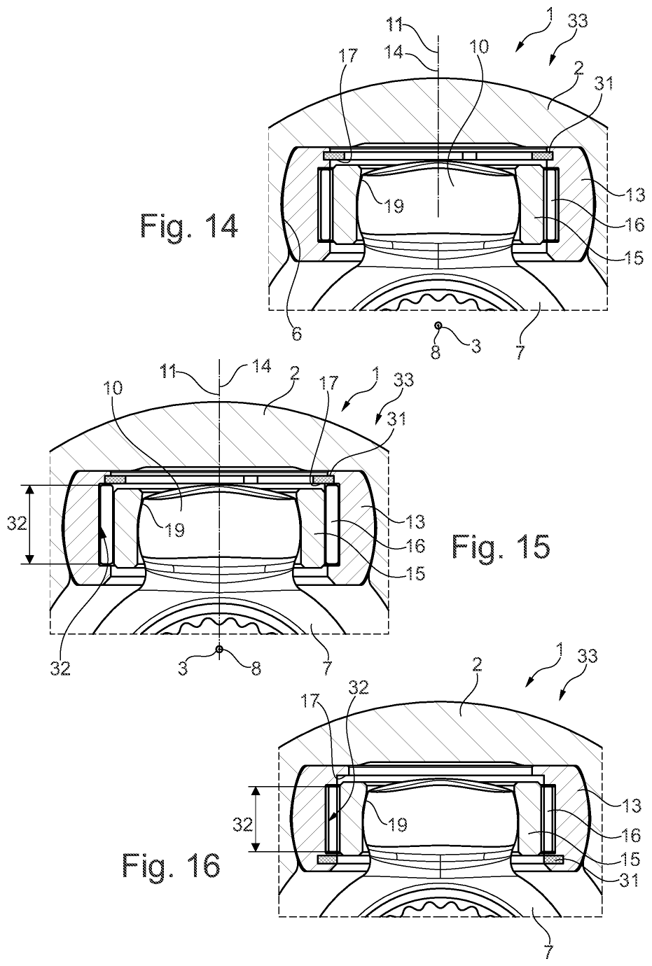

FIG. 15 shows a detail of a (first) cross-section 33 of a fifth design variant of a tripod joint 1. Reference is made to the explanations in FIG. 14.

Here an installation space 32 for the bearing bodies 16 on the outer ring 13 is limited by a circlip 31 arranged on the outer ring 13. The circlip is arranged in a circumferential groove on the outer ring 13, protruding from the groove so that the circlip contacts the inner ring 15 when the latter is displaced sufficiently far along the axis of rotation 14 and away from the second longitudinal axis 8.

As described, it is also possible that during the intended operation, at least in individual arrangements of the tripod joint 1, the circumferential surface 26 of the bearing bodies 16 contacts the contact surface 27 of the respective ring 13, 15, in this case the inner ring 15, over only part of the length 25. However, only a part of the length 25 of the circumferential surface 26 of the bearing bodies 16 is not contacted. This non-contacted part of the length 25 is exclusively arranged directly adjacent to the second side 21 of the bearing bodies 16 pointing away from the second longitudinal axis 8. The non-contacted length 25 is here at most 10% of the length 25 of the contactable circumferential surface 26.

This embodiment is chosen, for example, in the fifth design variant, when a circlip 31 is used to form the first stop 17, in which case the circlip also limits the installation space 32 for the bearing bodies 16.

FIG. 16 shows a detail of a (first) cross-section 33 of a sixth design variant of a tripod joint 1. Reference is made to the explanations on FIGS. 14 and 15.

Here, an installation space 32 for the bearing bodies 16 on the outer ring 13 is limited by a circlip 31 arranged on the outer ring 13. The circlip is arranged in a circumferential groove on the outer ring 13 and projects from the groove only to such an extent that the bearing bodies 16 are retained but the circlip does not contact the inner ring 15 when the latter is displaced towards the second longitudinal axis 8.

It is possible, but not shown, that the installation space 32 is limited on both sides 20, 21 of the bearing bodies 16, i.e., towards the second longitudinal axis 8 on the first side 20 and on the second side 21 facing away from the second longitudinal axis 8, by one circlip 31 each (i.e., e.g., according to a combination of FIGS. 14 and 16 or 15 and 16).

It is also possible that the circlip 31, which is arranged on the first side 20 of the bearing bodies facing the second longitudinal axis 8 and in a groove on the outer ring 13, extends at least partially beyond the inner ring 15 towards the axis of rotation 14, so that an anti-dismantling device for the roller body 12 is realized (the inner ring 15 can then no longer be pulled off the outer ring 13). The circlip 31 can directly limit the installation space 32 or be arranged at a distance from the installation space 32.

Furthermore, it is possible that the circlip 31 arranged towards the second longitudinal axis 8 on the first side 20 of the bearing bodies and in a groove on the outer ring 13 extends at least partially over the inner ring 15 towards the axis of rotation 14 and that a third stop 28 is realized by a projection on the inner ring 15 (see FIG. 13). In this case, a disassembly protection for the roller body 12 is realized on the one hand with respect to the rings 13, 15 (the inner ring 15 can no longer be pulled off the outer ring 13) and on the other hand with respect to the trunnion 10 (the inner ring 12 cannot be pulled off the trunnion 10—at least when the axis of rotation 14 and the trunnion axis 11 are arranged coaxially).

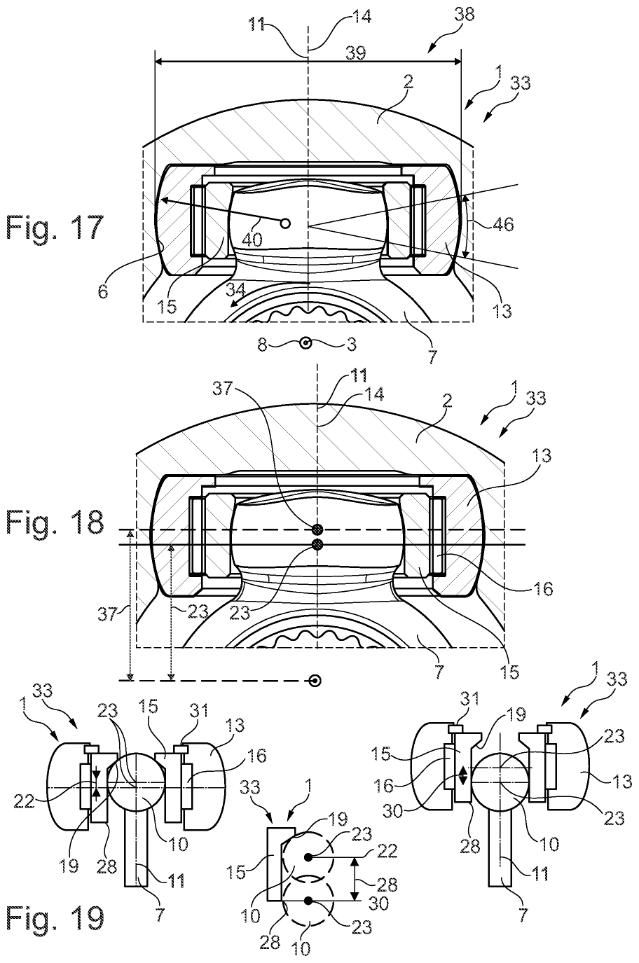

FIG. 17 shows the detail according to FIG. 1 with a first feature. Reference is made to the explanations in FIG. 1.

The outer ring 13 has a maximum diameter d 39 in a second cross section 38 encompassing the axis of rotation 14 and an outer circumferential surface of the outer ring 13 is formed by a radius r 40; where the following applies:

0.5<2*r/d<1.5.

When 2*r=d, a spherical outer circumferential surface is present.

For example, if the outer ring 13 of the roller body 12 has a spherical outer contour on its outer circumferential surface, the outer ring 13 can be pivoted or swiveled about the center axis of the recess 6 of the outer joint part 2 in the circumferential direction 34 of the central body 8. In this case, the recess 6 in the outer joint part 2 is shaped accordingly, so that the roller body 12 is not fixed in the circumferential direction 34 of the outer joint part 2, but can be pivoted on both sides with respect to the center axis of the path of the recess 6 in a range of, in particular, 0 to 5 angular degrees in accordance with a caused orbital movement. This pivoting is referred to as orbital movement or orbital angle 46. The central axis of the path is the axis of each recess 6 in the outer part of the joint 2, along which the roller bodies 12 can move as a result of the axial forces in the outer part of the joint 2.

In this case, the angular compensation of the orbital movement can also take place at least partially between the trunnion 10 and the inner ring 13. For this purpose, the circumferential surface of the trunnion 10 is convexly curved. The convex shape of this surface implies that the surface is designed according to a spherical segment, a barrel segment, a toroidal segment or a cylinder segment, e.g., with a cylinder axis parallel to the second longitudinal axis 8.

FIG. 18 shows the detail according to FIG. 1 with a second feature. Reference is made to the explanations for FIG. 1.

Here it is shown that a PCR1 23 of the inner joint part 7 is smaller than a PCR2 37 of the outer joint part 2, whereby the PCR 23, 37 is the pitch circle radius.

FIG. 19 shows a representation of the displacements RIM 30 (right representation) and ROM 22 (left representation) of the trunnion 10 of a tripod joint 1 between an undeflected and a maximally deflected position. The center illustration shows the total displacement, i.e., the sum of RIM 30 and ROM 22. Reference is made to the explanations on FIGS. 2 to 9 and 12.

The displacement path ROM 22 describes the displacement of the PCR1 23 (pitch circle radius) of the inner joint part 7 between a first state, in which the longitudinal axes 3, 8 are arranged coaxially to each other, and a second state, in which the longitudinal axes 3, 8 are deflected from each other to a maximum extent (maximum deflection angle 24 is present). These two states are shown in the middle illustration in FIG. 19. The inner ring 15, which is contacted by the second stop 19, is displaced together with the trunnion 10. This displacement of the inner ring 15 relative to the outer ring 13 should be realizable by the (possible) displacement path L 18, i.e., the inner ring 15 should only form or contact the first stop 17 with the outer ring 15 when the trunnion 10 is displaced to the maximum during intended operation (i.e., by ROM 22).

The (possible) displacement of the trunnion 10 with respect to the inner ring 13 is limited by the first stop 17 and, if applicable, by the third stop 28, wherein this (possible) displacement corresponds to at least RIM+ROM, i.e., the following applies:

Displacement RIM+ROM

wherein for RIM and ROM applies:

RIM=1.5*PCR1*(1−cos(betaₘₐₓ))

and

ROM=0.5*PCR1*(1−cos(betaₘₐₓ))

with RIM as the displacement path RIM 30 of the trunnion 10 starting from the PCR1 23 along the axis of rotation 14 towards the second longitudinal axis 8 (see right-hand illustration), with ROM as displacement path ROM 22 of the trunnion starting from the PCR1 23 along the axis of rotation 13 away from the second longitudinal axis 8 (see left-hand illustration), with PCR1 as pitch circle radius PCR1 23 of the inner joint part 7 and betaₘₐₓ as maximum deflection angle 24 of the tripod joint 1.

The third stop 28 is thus arranged in such a way that the above condition is fulfilled, i.e., that the (possible) displacement between the stops 17, 28 is greater than or equal to the sum of RIM 30 and ROM 22.

RIM, or “radial inward movement of tripod peg” (i.e., the radially inward displacement of the trunnion 10) refers to the displacement of the PCR1 23 (pitch circle radius) of the inner joint part 7 between a first state in which the longitudinal axes 3, 8 are arranged coaxially to each other and a second state in which the longitudinal axes 3, 8 are maximally deflected to each other (maximum deflection angle 24 is present). The trunnion 10 slides along the contact surface of the inner ring 15, which is particularly cylindrical. This displacement RIM 30 of the trunnion 10 relative to the inner ring 15 should be realizable, i.e., the trunnion 10 should not (yet) form the third stop 28 with the inner ring 15.

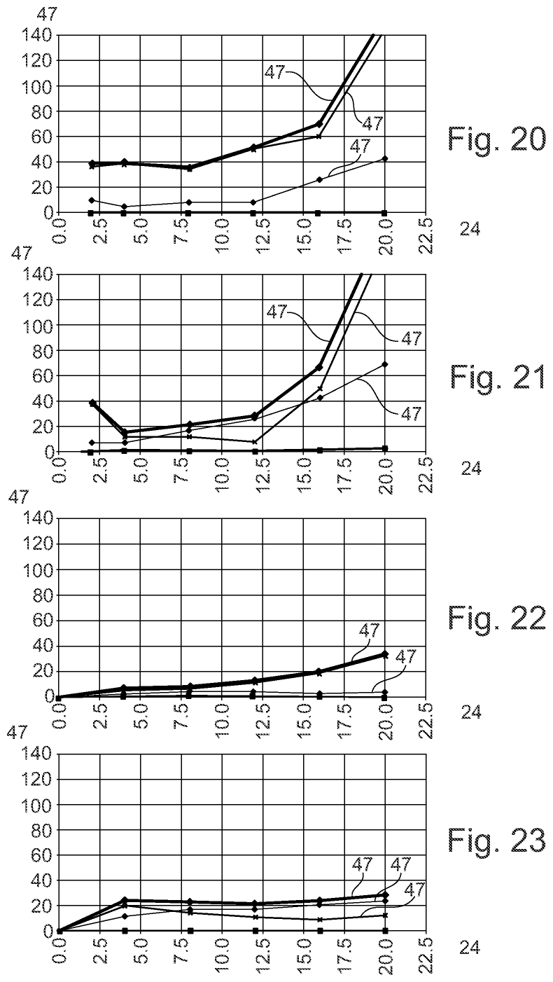

FIG. 20 shows a first diagram. FIG. 21 shows a second diagram. FIG. 22 shows a third diagram. FIG. 23 shows a fourth diagram. The diagrams are described together below.

On the horizontal axis the deflection angle 24 of the tripod joint 1 is plotted. The axial force 47 acting in the tripod joint 1 is plotted on the vertical axis.

The properties of a tripod joint 1 are defined, among other things, by a so-called ACFG value (Axial Cyclic Force Generation, unwanted axial forces 47 generated by the joint). This value is given as the root mean square value of the force, with the unit Newton root mean square [(Nrms). The value varies as a function of the deflection angle 24 of the joint 1, and the variation of the value as a function of the deflection angle 24 can be defined or determined for each joint. The range of use of the joint 1 is thus limited by a maximum deflection angle 24 at which the ACFG value does not exceed an amount that is still considered permissible. This ACFG value is plotted on the vertical axes of the diagrams in the unit Newton root mean square (Nrms).

The diagrams show the curves of the different orders of axial force 47 for the differently deflected tripod joint 1. The upper and left curves show the respective sum of the axial forces 47 of the different orders.

The first and second diagrams show the curves of the axial forces 47 for a known AARi tripod joint 1. It can be seen that the axial forces 47 increase sharply at higher deflection angles 24 of more than 7.5 angular degrees and more than 15 angular degrees respectively.

The third and fourth diagrams show the curves of the axial forces 47 for the tripod joint 1 described. It can be seen that the axial forces 47 remain comparatively low even at higher deflection angles 24.

The first and third diagrams show the tripod joint 1 in traction mode.

The second and fourth diagrams show the tripod joint 1 in push mode.

It can therefore be seen that the proposed tripod joint 1 achieves a reduction in the ACFG forces and the axial forces 47. At the same time, the installability of the roller body 12 on the respective trunnion 10 is enhanced (there is no or only a slight projection in the form of the third stop 28 on the inner ring 15). Furthermore, the existing stops 17, 19, 28 are designed more advantageously than in known joints 1. In addition, the tripod joint 1 is designed to be more resilient due to the greater first wall thickness 35.

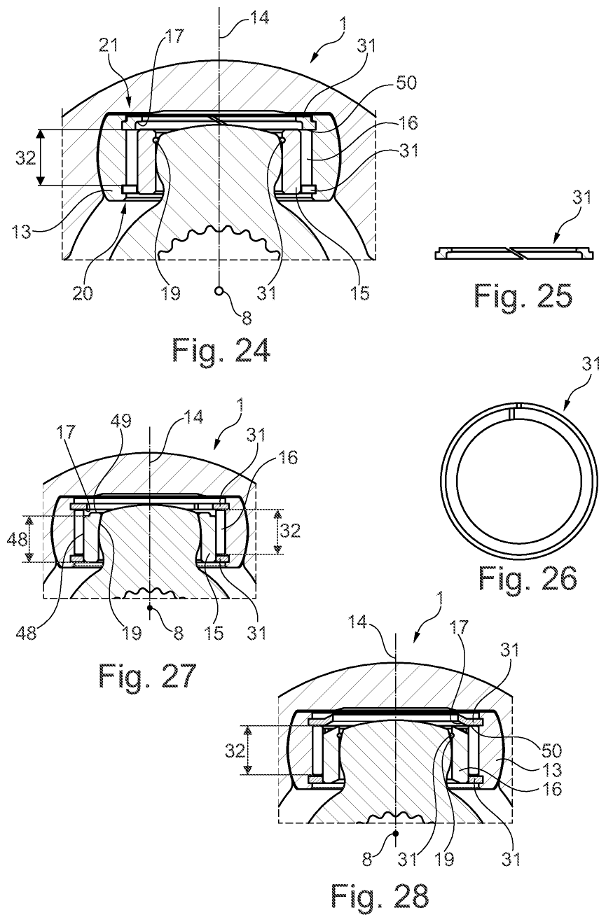

FIG. 24 shows a detail of a cross-section of a seventh design variant of a tripod joint 1. FIG. 25 shows a side view of the circlip 31 forming the first stop 17 according to FIG. 24. FIG. 26 shows the circlip 31 according to FIG. 25 in a top view. FIGS. 24 to 26 are described together below. Reference is made to the explanations of FIGS. 14 to 16.

Here, an installation space 32 for the bearing bodies 16 on the outer ring 13 is limited by a circlip 31 arranged on the outer ring 13. The circlip 31 is arranged in a circumferential groove on the outer ring 13 and projects out of the groove so that the circlip 31 contacts the inner ring 15 when the latter is displaced sufficiently far outwards along the axis of rotation 14 and away from the second longitudinal axis 8.

The installation space 32 is delimited on both sides 20, 21 of the bearing bodies 16, i.e., towards the second longitudinal axis 8 on the first side 20 and on the second side 21 facing away from the second longitudinal axis 8, by a respective circlip 31.

The circlip 31 for the first stop 17 has a stepped shape in the cross-section shown, so that the first stop of the circlip 31 acting towards the inner ring 15 is arranged along the axis of rotation 14 (outwards, i.e., away from the longitudinal axis 3, 8) offset from the groove in the outer ring 13 or from the fourth stop 50 formed by the circlip 31 acting against the bearing bodies 16. The stepped shape may comprise sections extending at right angles to each other (see FIG. 24) or sections extending at an angle to each other (see FIG. 28). The circlip 31 is slotted so that it is elastically deformable for mounting in the groove of the outer ring 13.

The second stop 19 is formed by a (different) circlip 31 arranged in a groove on the inner ring 15. The circlip 31 used for the second stop 19 has a round cross-section.

If a circlip 31 is used for the second stop 19, the inner ring 15 can be provided with a cylindrical inner circumferential surface, in which case the groove for receiving the circlip 31 is then provided in the inner circumferential surface.

FIG. 27 shows a detail of a cross-section of an eighth design variant of a tripod joint 1. Reference is made to the explanations on FIGS. 1 to 26 and on FIGS. 14 to 19.

Here, an installation space 32 for the bearing bodies 16 on the outer ring 13 is limited by a circlip 31 arranged on the outer ring 13. The circlip 31 is arranged in a circumferential groove on the outer ring 13, protruding from the groove so that the circlip 31 contacts the inner ring 15 when the latter is displaced sufficiently far along the axis of rotation 14 and away from the second longitudinal axis 8.

The inner ring 15 has a contour on its outer circumferential surface so that the inner ring 15 can be moved further along the axis of rotation 14 and away from the longitudinal axis 3, 8.

In this case, the inner ring 15 has a stepped shape (as a contour) in the first cross-section 33 shown, which runs transversely to the second longitudinal axis 8, so that a contact surface 48 of the inner ring 15, which interacts with the bearing bodies 16, is arranged offset inwards (i.e., towards the longitudinal axis 3, 8) along the axis of rotation 14 with respect to an end surface 49 of the inner ring 15, which points outwards along the axis of rotation 14. The end surface 49 of the inner ring 15 is the surface of the inner ring 15 furthest outwards (outwards along the axis of rotation 14, i.e., away from the longitudinal axis 3, 8).

FIG. 28 shows a detail of a cross-section of a ninth design variant of a tripod joint 1. Reference is made to the explanations on FIGS. 24 and 27.

Here an installation space 32 for the bearing bodies 16 on the outer ring 13 is limited by a circlip 31 arranged on the outer ring 13. The circlip 31 is arranged in a circumferential groove on the outer ring 13 and projects out of the groove so that the circlip 31 contacts the inner ring 15 when the latter is displaced sufficiently far along the axis of rotation 14 and away from the second longitudinal axis 8.

The circlip 31 has a stepped shape in a cross-section, so that a first stop 17 of the circlip 31 acting relative to the inner ring 15 is arranged along the axis of rotation 14 (outwards, i.e., away from the longitudinal axis 3, 8) offset from the groove in the outer ring 24 or from the fourth stop 50 formed by the circlip 31 acting against the bearing bodies 16.

The stepped shape comprises inclined sections. The inclined section of the circlip 31 interacts with a (substantially) parallel surface of the inner ring 15 and forms the first stop 17.

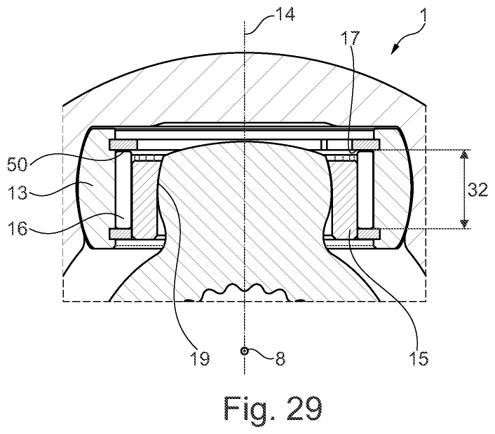

FIG. 29 shows a detail of a cross-section of a tenth design variant of a tripod joint 1. Reference is made to the explanations on FIGS. 24 and 28.

Here, an installation space 32 for the bearing bodies 16 on the outer ring 13 is limited by a circlip 31 arranged on the outer ring 13. The circlip 31 is arranged in a circumferential groove on the outer ring 13 and projects out of the groove so that the circlip 31 contacts the inner ring 15 when the latter is displaced sufficiently far along the axis of rotation 14 and away from the second longitudinal axis 8.

In contrast to the eighth design variant according to FIG. 28, the inner ring 15 has a cylindrical outer circumferential surface (i.e., without a contour deviating therefrom).

### LIST OF REFERENCE SIGNS

1 tripod joint
2 outer joint part
3 first longitudinal axis
4 cavity
5 end
6 recess
7 inner joint part
8 second longitudinal axis
9 central body
10 trunnion
11 trunnion axis
12 roller body
13 outer ring
14 rotation axis
15 inner ring
16 bearing body
17 first stop
18 displacement path L
19 second stop
20 first side
21 second side
22 displacement path ROM
23 pitch circle radius PCR1
24 deflection angle betaₘₐₓ
25 length
26 circumferential surface
27 contact surface
28 third stop
29 smallest angle
30 displacement path RIM
31 circlip
32 installation space
33 first cross-section
34 circumferential direction
35 first wall thickness
36 second wall thickness
37 pitch circle radius PCR2
38 second cross section
39 largest diameter d
40 radius r
41 motor vehicle
42 spline
43 shaft
44 first curve
45 second curve
46 orbital angle
47 axial force (ACFG)
48 contact surface
49 end face
50 fourth stop

1.-15. (canceled)

16. A tripod joint, comprising:
a joint outer part including a first longitudinal axis and a cavity running parallel to the first longitudinal axis with an open end, wherein three recesses running parallel to the first longitudinal axis are formed in the joint outer part; and
a joint inner part including a second longitudinal axis and a central body on which three trunnions are formed with trunnion axes extending radially from the second longitudinal axis, wherein respective roller bodies are arranged on each of the trunnions, wherein each roller body has an outer ring and an inner ring rotatable therewith about a common axis of rotation, as well as bearing bodies arranged between the outer ring and the inner ring, and wherein each roller body is movably received in the recesses, movable along the first longitudinal axis;
wherein, for each of the roller bodies:
one of the inner ring and outer ring together with the bearing bodies is displaceable relative to the other of the inner ring and outer ring along the common axis of rotation;
wherein the outer ring forms with the inner ring a first stop which limits a displacement path L of the inner ring relative to the outer ring along the common axis of rotation and away from the second longitudinal axis;
wherein, at least when the common axis of rotation and the trunnion axis are arranged coaxially, the inner ring forms, with the trunnion, a second stop that limits a displacement of the inner ring along the trunnion axis towards the second longitudinal axis; and
wherein the displacement of the inner ring relative to the trunnion along the trunnion axis away from the second longitudinal axis is limited only by the first stop.

17. The tripod joint of claim 16, wherein for each of the roller bodies the first stop is arranged along the common axis of rotation on a first side of the bearing bodies facing towards the second longitudinal axis or on a second side of the bearing bodies facing away from the second longitudinal axis.

18. The tripod joint of claim 16, wherein, for each of the roller bodies:
for the displacement path L: L>0.7*ROM;
ROM=0.5*PCR1*(1−cos(betaₘₐₓ)); and
ROM represents a displacement path of the trunnion starting from a pitch circle radius (PCR1) of the inner joint part along the common axis of rotation away from the second longitudinal axis, and betaₘₐₓ represents a maximum deflection angle of the tripod joint.

19. The tripod joint of claim 16, wherein, for each of the roller bodies:
the inner ring forms with the trunnion a third stop that limits displacement of the inner rings along the trunnion axes away from the second longitudinal axis; and
the inner ring and the trunnion contact each other via the third stop only in non-operation and only in an attempted disassembly of the inner ring from the trunnion.

20. The tripod joint of claim 19, wherein, for each of the roller bodies:
wherein the inner ring can only be pushed onto the trunnion in a pivoted state relative to the trunnion axis due to the third stop; and
wherein the pivoted state has a smallest angle between the trunnion axis and the common axis of rotation of 5 to 20 angular degrees.

21. The tripod joint of claim 20, wherein, for each of the roller bodies:
the displacement of the inner ring is limited by the first stop and the third stop, the displacement being at least equal to RIM+ROM;
RIM=1.5*PCR1*(1−cos(betaₘₐₓ)) and ROM=0.5*PCR1*(1−cos(betaₘₐₓ);
RIM is a displacement movement of the trunnion starting from a pitch circle radius (PCR1) along the common axis of rotation towards the second longitudinal axis;
ROM is a displacement path of the trunnion starting from the PCR1 along the common axis of rotation away from the second longitudinal axis;
PCR1 is a pitch circle radius PCR1 of the inner joint part; and
betaₘₐₓ is a maximum deflection angle of the tripod joint.

22. The tripod joint of claim 16, wherein, for each of the roller bodies, the displacement of the inner ring along the trunnion axis away from the second longitudinal axis is unrestricted when the trunnion axis and the common axis of rotation are arranged coaxially in non-operation.

23. The tripod joint of claim 16, wherein, for each of the roller bodies, the first stop is formed by the outer ring or by a circlip arranged on the outer ring.

24. The tripod joint of claim 16, wherein, for each of the roller bodies, the inner ring has a stepped shape in a first cross-section extending transversely to the second longitudinal axis, so that a contact surface of the inner ring cooperating with the bearing bodies is arranged offset inwardly along the common axis of rotation relative to an end surface of the inner ring.

25. The tripod joint of claim 16, wherein, for each of the roller bodies, an installation space for the bearing bodies on the outer ring is limited by a circlip arranged on the outer ring.

26. The tripod joint of claim 25, wherein, for each of the roller bodies, the circlip has a stepped shape in a first cross-section extending transversely to the second longitudinal axis, so that a fourth stop of the circlip acting with respect to the inner ring is arranged offset outwardly along the common axis of rotation with respect to a fifth stop formed by the circlip with respect to the bearing bodies.

27. The tripod joint of claim 16, wherein the joint inner part has, in a first cross-section extending transversely to the second longitudinal axis and between a PCR1 (pitch circle radius) of the inner part of the joint and the central body, a smallest first wall thickness present along a circumferential direction about the second longitudinal axis and a greatest second wall thickness on the radius of the PCR1, wherein the ratio of first wall thickness/second wall thickness is at least 0.7.

28. The tripod joint of any claim 16, wherein a first pitch circle radius of the inner joint part is smaller than a second pitch circle radius of the outer joint part.

29. The tripod joint of claim 16, wherein, for each of the roller bodies, the outer ring has a maximum diameter d in a second cross-section encompassing the axis of rotation and an outer circumferential surface of the outer ring is formed by a radius r; wherein 0.5<2×r/d<1.5.
